(19) United States
(12) Patent Application Publication
(10) Pub. No.: US 2010/0218131 A1
(43) Pub. Date: Aug. 26, 2010

(54) MULTIPLE VIEWS OF MULTI-DIMENSIONAL WAREHOUSE LAYOUT

(75) Inventors: Morten Holm-Petersen, Copenhagen (DK); David J. Kocmick, Holte (DK)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/390,515

(22) Filed: Feb. 23, 2009

(51) Int. Cl. G06Q 20/00

(52) U.S. Cl. 715/771

(57) ABSTRACT

Architecture for generating and manipulating a multi-dimensional visualization (e.g., top-down) of a physical layout of a warehouse. The visualization also provides graphical representation of computed pick rates of products in bins in the warehouse to support optimization of the location of the bins, and direct manipulation of the bins to move the bins to aisle and rack locations that provide optimized pick rates for the products being currently processed. An algorithm computes pick rate data and displays in association with each rack a color for the most deviating pick rate in the rack. Other visualization functionality is provided to expose suggestions for product movement. The visualization also employs a metaphor of “mirrors” to provide a horizontal view onto the sides of aisles in the warehouse.

### BACKGROUND

Companies that manage a warehouse from which items are picked for sales orders may use existing algorithms to calculate locations of products in the warehouse so that products that are picked more often are close to the packing area in order to minimize pick routes. ERP (enterprise resource planning) software can represent the product “bins” in a tabular form; however, this fails to provide users with an understanding of where the product is physically stored. Moreover, pick frequency data is not correlated with a physical map to assist users in understanding if all current “hot” items are really placed the closest to the packing area.

Some add-on software packages provide a 3D view of the warehouse layout. However, these packages fail to provide a realistic visualization of a warehouse that includes a clear line-of-sight to all bins in aisles of back-to-back racks. Thus, the conventional software tools require the user to interact with the visualization using an inordinate amount of zoom and rotation to obtain a view where bins in racks of interest are not occluded by other racks. Additionally, a zoomed-in view fails to provide an overview of where in the warehouse the product in focus might also be stored. Still further, once users understand, via the visualization, that a bin is incorrectly placed for more efficient product picking, the user is not provided the functionality to directly manipulate the visualization to move the bin.

The user is limited to the editing of electronic forms that describe the source and destination bin content. Moreover, the existing software tools that allow users to view or build 2D and 3D models of warehouse layouts focus on the layout of aisles and racks and do not dynamically visualize the actual pick rates for the products currently stored in each bin.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides for the creation and utilization of a multi-dimensional visualization (e.g., top-down) of a physical layout of a warehouse. The visualization also provides graphical representation of computed pick rates of products in bins in the warehouse to support optimization of the location of the bins. The architecture allows for direct manipulation of the bins in the visualization to move the bins to aisle and rack locations that provide optimized pick rates for the products being currently processed. In other words, the visualization allows users to do “re-slotting” of bin content through direct manipulation by dragging-and-dropping a graphical representation across the view from one bin to another.

The visualization can now be defined by the warehouse manager or other similarly-situated employees (rather than more specialized assistance such as consultants) using interaction directly in the view. The view can use color or other indicia to visualize dynamically up-to-date values (e.g., pick rate) for each rack and bin, for example.

The architecture employs an algorithm to compute pick rate data and display, in association with each rack (e.g., on top of each rack), an identifying indicia such as color for the bin with the most deviating pick rate in the rack. This can also depend on a “bin rank location” so that bins with high pick rates are highlighted in low bin rank locations and bins with low pick rates are highlighted in high bin rank location. In other words, the algorithm also highlights the most urgent bins to move to a more efficient warehouse location. The visualization also provides a slider (and other functionality) that allows a user to reduce or increase a number of suggestions to be presented while keeping the most urgent suggestions visible.

Additionally, the visualization uses a metaphor of mirrors to provide a horizontal view onto the sides of aisles in the warehouse. The metaphors can function as pop-ups that appear in response to hovering of a pointer of a computer pointing device over the desired rack location.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented visualization system in accordance with the disclosed architecture.

FIG. 2 illustrates an implementation of a virtual warehouse that employs mirror metaphors for multi-dimensional viewing of product storage locations.

FIG. 3 illustrates a screenshot of a visualization of an exemplary graphical representation of a warehouse layout and pick activity information.

FIG. 4 illustrates a visualization of a thirty-day historical representation from the data tables.

FIG. 5 illustrates a visualization method.

FIG. 6 illustrates a method of providing differentiating graphics for product bins.

FIG. 7 illustrates a method of product item relocation processing.

FIG. 8 illustrates a method of suggesting bins for optimized pick location.

FIG. 9 illustrates a block diagram of a computing system operable to execute multi-dimensional warehouse layout and interaction visualizations in accordance with the disclosed architecture.

### DETAILED DESCRIPTION

The disclosed architecture facilitates the generation and manipulation of a multi-dimensional visualization (e.g., top-down) of a physical layout of a warehouse or other structure where item placement and movement is tracked for optimum processing. The visualization provides a graphical user interface (GUI) for representing the virtual warehouse physical layout, aisles, racks on the aisles, bins in the racks, and products in the bins. A user can directly relocate bins to aisle and rack locations that provide shorter pick routes for employees and/or automated pickers for the products being currently processed. The visualization is also supported by one or more algorithms that compute data to be represented and viewed as applied to specific areas of the virtual warehouse. The data includes pick rate data which can be associated with each rack as a changing color (or other suitable indicia) that maps to the pick frequency per bin. The visualization also employs a metaphor of “mirrors” (a virtual camera view) to provide a horizontal view onto the sides of aisles in the warehouse.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

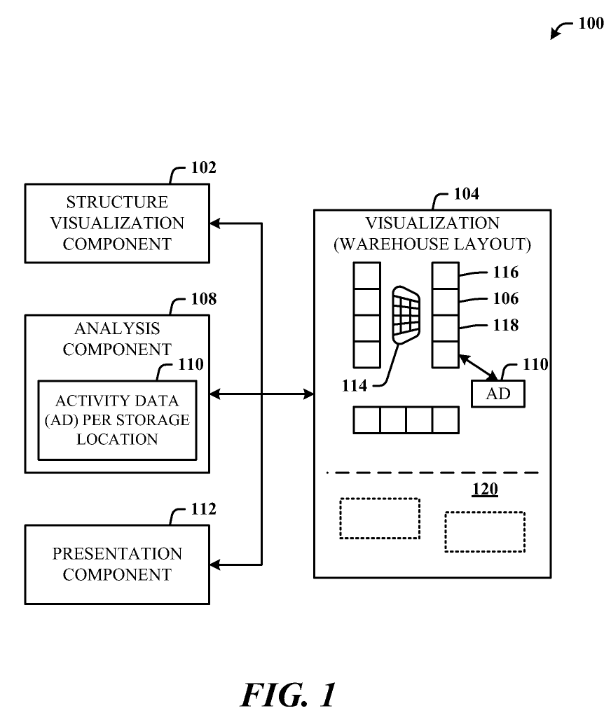

FIG. 1 illustrates a computer-implemented visualization system 100 in accordance with the disclosed architecture. The system 100 includes a structure visualization component 102 for creating and presenting a visualization 104 of a warehouse layout (or other structure) having aisles of storage locations 106 for storing product items. The system 100 also includes an analysis component 108 for computing activity data 110 of item activity for the storage locations 106. The system 100 can also include a presentation component 112 for graphically representing the activity data 110 in association with storage locations 106.

The visualization 104 of the warehouse is a multi-dimensional view of the layout that includes top-down views and angular views, for example. The presentation component 112 graphically represents changes in the activity data 110 using corresponding changes in coloration, for example, of the storage locations 106. The visualization 104 includes a mirror metaphor 114 for manipulating views of a storage location. The visualization 104 facilitates user interaction for moving items (or bins) of one storage location 116 to another storage location 118. The presentation component 112 applies visual emphasis (e.g., coloration such as grayscaling, highlighting, bolding, etc.) to specific storage locations (e.g., storage location 116) to suggest movement of the specific storage locations to different storage locations. The visualization 104 includes a graphical control for selecting a number of suggestions to be presented for item relocation. The presentation component 112 maintains presentation of higher priority suggestions in the visualization 104 independent of the number of suggestions selected. The presentation component 112 also applies emphasis to a specific storage location based on distance of the specific storage location from a work area 120.

In terms of pick rate, which is the rate at which product items are pulled from a storage bin (location), the visualization system 100 comprises the structure visualization component 102 for creating and presenting the multi-dimensional visualization 104 of the warehouse layout having the storage locations 106 for the storage of product items, the analysis component 108 for computing pick activity data 110 relating to picking items from the storage locations, and the presentation component 112 for graphically representing the pick activity data 110 in association with storage locations 106.

The visualization 104 of the warehouse is a multi-dimensional view of the layout that includes top-down views and side views of the storage locations 106, the presentation component 112 applies visual emphasis to specific storage locations to suggest movement of the specific storage locations to different storage locations, and the visualization 104 facilitates user interaction for moving items of one storage location to another storage location based on the suggestion. The visualization 104 includes the metaphor 114 of mirrors for accessing side views of aisle racks. The presentation component 112 graphically represents on top of each rack an indication for a most deviating pick rate of the rack.

Other applications of coloration, or more generally, mechanisms for providing visual emphasis, can be utilized for denoting shelves available based on structural support capability, how full a bin is based on volume, as an indication as to how heavy items are in the bin, the dollar value, the length of time the product has been sitting without any pick activity, or how long since the bin was counted, for example. Counting can then be optimized when it is estimated that the bin count will be low, since the time needed to then perform the count will be small. Additionally, the pick frequency, the number of times the item is picked per day, week, month, etc., can be computed and tracked.

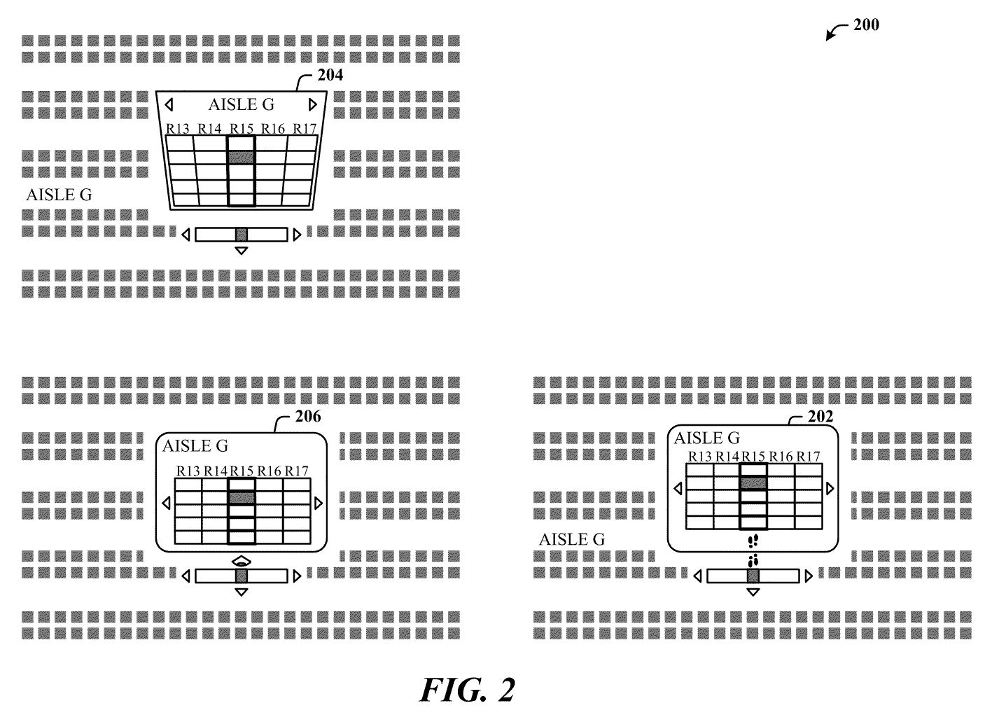

FIG. 2 illustrates an implementation of a virtual warehouse 200 that employs mirror metaphors for multi-dimensional viewing of product storage locations. Three different types of metaphor perspectives are shown. A first metaphor 202 is applied to an Aisle G. The first metaphor 202 is presented as if the viewer was standing in front of the storage locations (e.g., a ninety-degree or perpendicular presentation). The viewer can be represented by a graphic of a person (represented by footprints) that can be turned according to the view desired by the user. Here, the metaphor 202 exposes five rack locations (R13-R17), two racks in either side of the rack of interest (rack R15), where each rack has five shelves. Each rack shelf can be a product storage bin that holds product items for picking. In a bulk area, each shelf can be where a pallet of product is stored. In other words, the racks can be similar to what the user may experience in a retail store or large storage locations that support bulk storage such as pallets.

The first metaphor 202 also includes navigation tools for left and right navigation in the Aisle G, should the user choose to do so. A second metaphor 204 is presented from a perspective looking downward in the Aisle G at an angle, such as forty-five degrees, for example. Navigation can be left and right, as before. A third metaphor 206 presents a different icon (an eye) that indicates the direction of view of the racks. The “eye” icon can be manipulated as a means for navigating along the aisle or a different aisle and looking at different rack locations.

The visualization of the warehouse is not defined by expensive consultants but by the warehouse manager or other warehouse personnel using simple interaction directly in the view. The view can use emphasis such as color to visualize dynamically up-to-date values (e.g., pick rate) for each rack. The top-down view uses one or more an algorithms (the analysis component) to expose and display (e.g., on top of each rack) a color or other suitable indicia for the most deviating pick rate in a rack. The most deviating pick rate is determined based on the rack's “bin rank location” which ranks the bins in each rack relative to the bin distance from the packing tables.

As previously indicated, the top-down visualization uses a metaphor of mirrors to provide a horizontal view onto the sides of aisles in the warehouse. The visualization also allows users to perform “re-slotting of bin content” through direct manipulation by dragging bins and/or the content of a bin across the view to another bin. Moreover, the visualization supports an algorithm that highlights the most urgent bins to move. A slider is presented that lets users reduce or increase the number of suggestions to be presented for product relocation while maintaining the most urgent suggestions visible.

Warehouse personnel (e.g., managers) can create the warehouse layout by specifying warehouse dimensions in meters/yards and in an X and Y grid. The grid can be presented in one-meter or one-yard tiles, for example. On top of this grid, the user can drag out lines to indicate the center line of each aisle, and then specify for each aisle the number of racks and shelves into which the aisle is split.

Pick frequency data can be visualized per physical location so users can judge if the products with the highest pick frequencies are located nearest to the packing area. To visualize pick frequencies in a top-down view of vertically stacked bins an algorithm exposes the “most interesting” bin from each rack. Bin rank values are assigned to every rack to indicate how close the rack is to the packing area. In racks close to the packing area, the bin with the lowest pick frequency is visualized on top of the rack to highlight “cold” products (e.g., with a corresponding “cold” color such as blue, or other desirable indicia) that are moved infrequently and that should be moved to the back of the warehouse. For racks far from the packing area, the bin with the highest pick frequency is visualized on top of the rack to highlight “hot” bins (e.g., with a corresponding “hot” color such as orange or yellow) that should be moved closer to the packing area.

The mirror metaphor allows the user to select a specific rack in an aisle and view the individual bins of the selected rack, as well as neighboring racks, while maintaining a view of the entire warehouse floor where other bins storing the same product are highlighted. This means that users can focus on the business task and not need to manipulate the view port (e.g., zoom in, zoom out, rotate, etc.).

The use of focus plus context (or fish-eye) view is adapted to the warehouse layout by using the metaphor of an angled mirror. When a rack is selected, the angled mirror appears next to the rack so users from the top-down perspective can look onto the side of the racks to see the individual shelves with bins. The mirror is semi-transparent so an occurrence of the same product under the mirror is still visible.

When a user realizes that a product is incorrectly placed in the warehouse for improved pick rate, the user can simply drag the product from its current bin to an empty bin somewhere else in the warehouse. Users can also drop the content of a half-empty bin into another half-empty bin of the same product.

When a bin is selected, the visualization highlights other bins in the warehouse that hold the same product. While dragging bin content, the visualization highlights empty bins and bins with the same product as potential drop targets.

An algorithm (included as part of the analysis component) related to the visualization can suggest bins to move to optimize product location for picking. The algorithm calculates an index value for each bin to indicate how much the bin's pick frequency deviates from the bin's location.

All bins are sorted in a list based on bin rank (with bins closest to packing area ranked at or near the top of the list). A count of bins is calculated for each bin rank value. The list of bins is then sorted by the bin pick frequency (highest first). The pick frequencies are then chunked by bin rank values starting from the top using the count of bins per bin rank value calculated earlier. The bin rank that each bin falls into is tagged onto the bin as a suggested bin rank. Additionally, each bin is assigned an index value, which can be a value=100 if an actual bin rank and suggested bin rank of the bin are identical. A higher suggested bin rank value produces a progressively higher index value, and a lower suggested bin rank value produces a progressively lower index value.

By default, the visualization can be set to highlight (or visually emphasize) the twenty-five highest and twenty-five lowest index values. A slider, for example, attached to the visualization lets users increase or decrease the number of highlighted bins, which also adjusts the number of suggested bin movements to a number found relevant to move. As the slider reduces the number of suggestions, index values closest to the value=100 are visually removed and bins having numbers the furthest away from the value=100 remain highlighted.

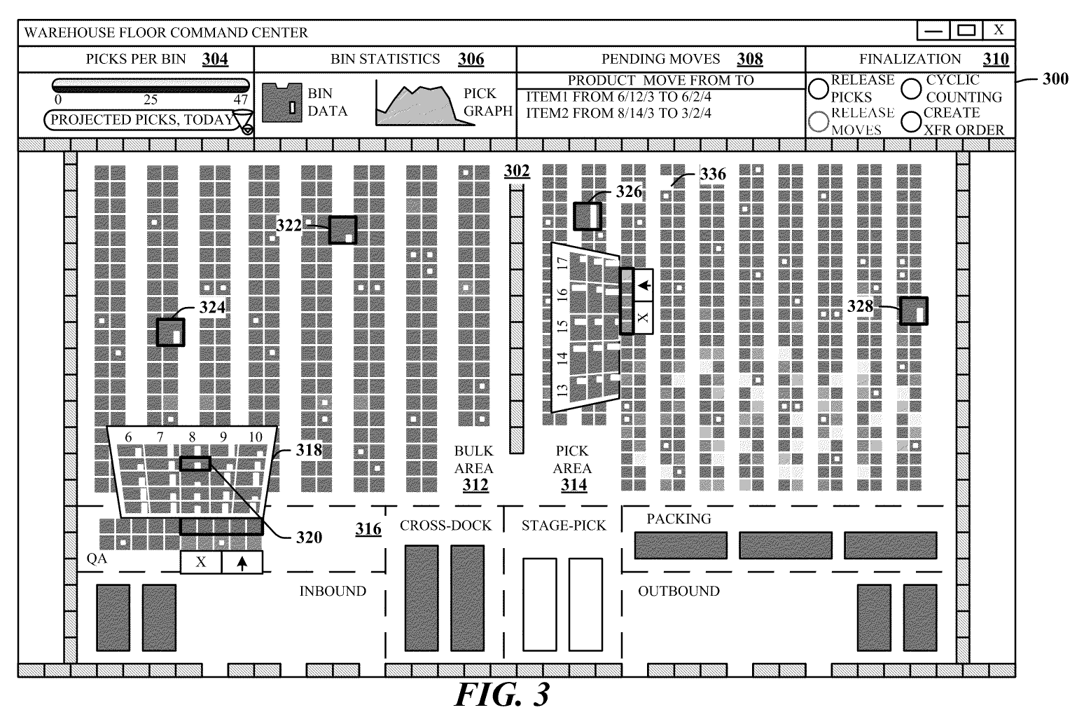

FIG. 3 illustrates a screenshot of a visualization 300 of an exemplary graphical representation of a warehouse layout and pick activity information. The visualization 300 includes a floor layout section 302, a picks per bin section 304, a bin statistics section 306, a pending moves section 308, and finalization section 310.

The floor layout section 302 shows three general areas: a bulk area 312 (on the left) for stacking and storing product in bulk, a pick area 314 (on the right) for stacking and storing product by items in bins, and a preparation area 316 (along the bottom) for inbound and outbound product processing (shipping and receiving).

In the pending moves section 308, when the user moves (e.g., drag and drop) the contents of a bin to another bin (e.g., as the user interaction drops into the receiving bin), a line item is added in the pending moves section 308 that presents details about the move, for example, the product is being moved from aisle A rack B bin C (represented A/B/C) to aisle X rack Y bin Z (represented X/Y/Z). Thus, a listing of the simulated changes is provided.

By selecting one of the icons in the finalization section 310 related to functionality that releases picks, releases moves, etc., a result is to feed the activities back to an enterprise resource planning (ERP) system (e.g., a business application). The results are written into tables as if the user had manually entered the data into the desired forms. Warehouse workers can then see the table data and effect changes on the warehouse floor based on that data. As illustrated, the finalization section 310 includes functionality for releasing picks, releasing moves, creating a transfer order, and cyclic counting. Other or different functionality can be provided as desired.

In a “low tech” warehouse, the workers print out the move requests and then physically execute the product moves. In a “high tech” warehouse, the workers may have a handheld device that receives the table data and presents the move information for product that needs to be moved. In a robotic warehouse, the robot performs the product moves in response to the move requests defined by the table data.

However, the disclosed architecture not only provides the capability of multi-dimensional graphical representation and interaction, but also the ongoing analysis and guidance as to what product items should be moved to a location that optimizes outbound (or inbound) product handling and processing. Generally, this would typically mean that items for picking will be located closer to the preparation area 316 for packing and shipping. If the items are not optimally located, the graphical representation provides up-to-date evaluation and presentation of the current state of the product items. Thus, the worker can quickly review and understand several pieces of information about the state of the product items. Color-coding such as gray-scaling can provide indications as to items that are most active for packing and the location of these items. For example, a blue color can indicate that the items for a bin are not being picked at a high rate, if at all, while an orange color (or lighter gray) can indicate that the bin items are undergoing active picking.

The picks per bin section 304 includes a legend in the form of a color gradient that relates pick rate to the color shown on the representation. The pick rate is referred to as “hot” (very high pick activity) toward the lighter color (e.g., orange or light gray), and “cold” (little or no pick activity) toward the darker (e.g., blue or gray) color. As illustrated, most of the bins in the bulk area 312 are cold, although 3-4 of the bins show slight pick activity due to the slightly lighter shading of the associated bins. In the pick area 314, bin coloration indicates that for the most part product location is good, since items undergoing a high pick rate (as presented by the light coloration) are close to the packing area.

As illustrated, the visualization 300 can represent a snapshot of product picks for a particular time duration such as a duration of one day, for example. In the top left portion of the pick area 314, there is illustrated a light colored bin 336 indicating that warehouse users currently (e.g., today) will need to access that bin frequently to pick product items for packing. For more optimum processing, the worker can drag that bin graphic (or a whole pallet from the bulk area 312) closer to the packing area to effect more efficient picking, since the workers will no longer need to move back and forth over a greater distance. The bin move request is then processed to get the bin moved to the location of the drop (of the drag-and-drop).

From a physical perspective, the layout includes aisles, racks in the aisles, bins in the racks, and items in the bins. Note that the representation shows a dot (e.g., white) on top of some of the racks. The white dot indicates that at some level in this rack of shelves there is an empty bin space (or shelf). Thus, the worker can choose to drop a bin into one of many racks that show an empty bin space.

A mirror metaphor 318 (similar to the metaphors 114 of FIG. 1, and 202, 204, and 206 of FIG. 2) allows the user to view and receive information as to bin item counts in racks. Consider the metaphor 318 in the quality assurance (QA) area in the lower left of the preparation area 316. The metaphor 318 shows five racks (Racks 6-10) each having five bins stacked vertically. A specific bin 320 (Rack 8, Bin 4) is selected (as indicated by being circumscribed). In response to selecting the bin 320, four other bins that contain the same product in the warehouse are emphasized for viewing: a first bulk bin 322 and a second bulk bin 324 in the bulk area 312, and a first pick bin 326 and a second pick bin 328 in the pick area 314. It can be typical that there be two pallet bins (the bulk bins 322 and 324) in the bulk area 312 that store the same product, and there can also be a bin in the pick area 314 that holds the product and possibly another bin in the pick area 314 that has a few items remaining.

In some bin replenishment methods, bin items removed from a bin are not replenished in that bin, but the bin is emptied and then replaced with a full bin. Moreover, picking initiated in a bin continues to empty that bin before picking items from another bin. This means that worker movement changes throughout the pick area 314 based on where a specific product is stored. This is reflected in the visualization 300 where the first pick bin 326 and the second pick bin 328 in the pick area 314 hold the same product. The graphic associated with the first pick bin 326 includes a simplified bar chart that indicates first pick bin 326 is full (extends from bottom to top in the graphic), whereas the graphic for the second pick bin 328 indicates about half full. Thus, the second pick bin 328 is being picked from before the first pick bin 326. When the second pick bin 328 is emptied, the system will indicate to the worker(s) to begin picking from the first pick bin 326. Similarly, in the bulk area 312, the graphic associated with the first bulk bin 322 includes a bar chart indicating the bulk product stored in the first bulk bin 322 and supporting the pick area 314 is nearly empty, whereas the graphic associated with the second bulk bin 324 includes a bar chart indicating the bulk product stored in the second bulk bin 324 and supporting the pick area 314 is about half full.

In operation, the warehouse manager will access a representation similar to that shown in FIG. 3, to estimate sensible pick locations for the day. For example, the warehouse manager can move (e.g., drag-and-drop) the light-colored bin 336 at the top of the pick area 314 closer to the packing area. It can also be the case that the warehouse manager, just for today (as indicated in the picks per bin section 304), moves the pallet identified by the first bulk bin 322 directly from the bulk area 312 down to the preparation area 316 designated the stage-pick area. Thus, a particular product pallet can be quickly staged for any given purpose. This further optimizes pick processing by moving the pick items even closer to the packing area. Workers then pick items directly from the stage-pick area, or in combination with the pick area 314. At a later time, the manager can “drag” the pallet back to the bulk area 312.

Another use of the disclosed architecture is to move “questionable” products or items to the QA area, for example, for inspection. For example, if the product or item is experiencing high failure rates, a recall inspection, is contaminated by dust, moisture, damaged, etc., the worker can move it over to the QA area for re-inspection. Another example clears a whole rack or aisle for an incoming delivery.

In the picks per bin section 304, a funnel icon, for example, indicates the ability to apply filtering. The funnel is associated with a drop-down menu for selecting filter criteria; however, alternative filtering navigation mechanisms can be employed, if desired. FIG. 3 illustrates the projected picks for one day. The criteria time span can include the next hour, next six hours, full day, next week, and so on. If looking at an 8-hour period of product picks for the current day, the representation can show several “hotspots”, which are areas of light colors (e.g., orange, yellow, light gray, etc.) where the pick rates are expected to be high. Then these areas can be addressed sequentially throughout the day. The aggregate picks of a 1-day order is what affects the coloration for designating the hotspots. Throughout the time span, the lighter colors will grow darker (colder) as the pick rate goes down or the bins empty.

In an alternative pick process, orders can be fulfilled on a bulk basis. In a company that has many orders bulk picking can be employed. In other words, all sales orders that will go out for delivery by a specific time (e.g., at 2 PM today) are picked together. In this case, the worker goes to the bin only once and takes the sum of items needed for all the sales orders. This tactic can work efficiently for a high volume order.

The individual bin locations in the metaphor 318 can also be differentiated, for example, by distinctive color or gradients of the same color. Additionally, each bin in the metaphor 318 can include the bar chart representation as a quick means for representing the product items remaining in the bin. In the bin statistics section 306, specific data (represented by the block Bin Data) can be presented (listed) for the bin 320 selected in the metaphor 318. Here, the Bin Data for the bin 320 can include items designated Scarf-Paris-Women-Black-L, with a Product #339, a capacity in the bin of ninety units, zero picks have been made, and a location of DA-8-5808. A graph (Pick Graph) of the number of picks versus the last thirty days can also be presented for a quick historical view. Other bin statistical data can be presented as desired, and in different ways.

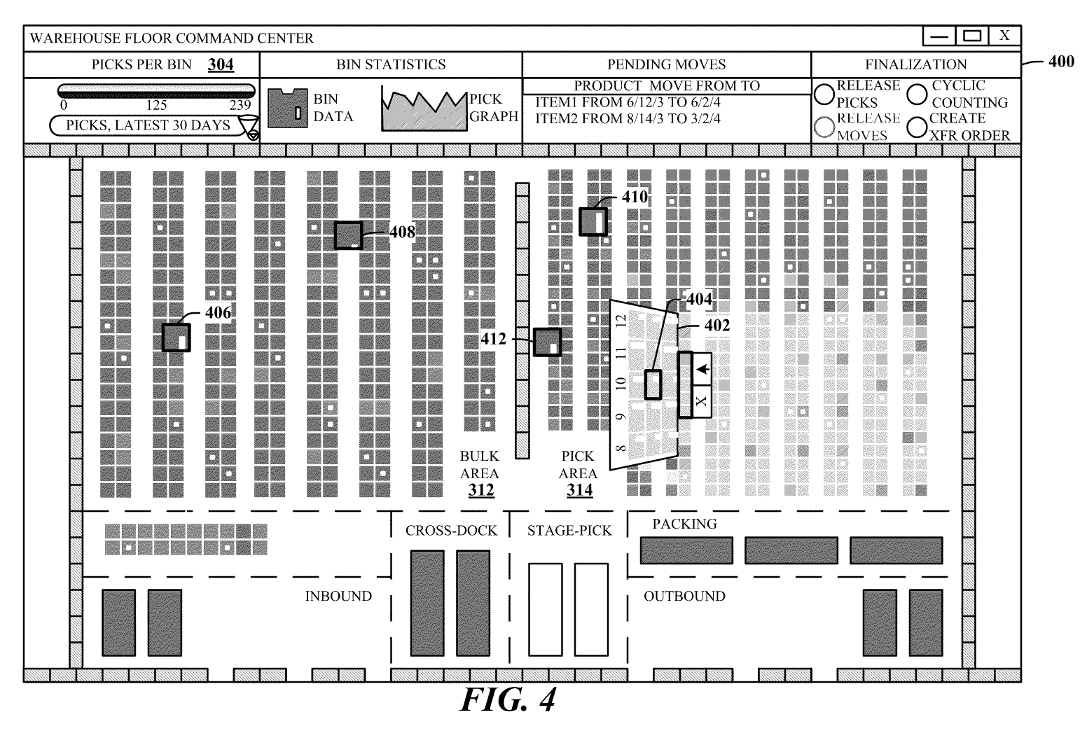

FIG. 4 illustrates a visualization 400 of a thirty-day historical representation from the data tables. In other words, the values in the data tables for the last thirty days are aggregated on the visualization 400 to show an composite view of product picks over the last thirty days (as indicated in the picks per bin section 304). Similarly, a table stores information related to the moves.

Less efficient systems can use paper to track the picks and initiate item movement. Changes are then input manually for presentation in the visualization as the day progresses. In a more robust system items can be tagged with RFID (radio-frequency identification) devices such that when the item is removed from the bin, an RFID reader immediately notes the removal and transmits this information for processing, pick rate analysis, and any changes that may be desired in the visual emphasis (e.g., coloration, highlighting, bolding, circumscribing, etc.) for that rack, and bin. An alternative tracking mechanism can use barcodes for manual or robotic tracking to provide immediate feedback so that the visualization 400 can change color, for example, more closely related to realtime activities (e.g., second by second).

Here, the user has moved a mirror metaphor 402 in front of racks 8-12 of an aisle in a hot area (bins of lighter color) of the pick area 314. A bin 404 in Rack 10, second shelf, is selected, thereby also presenting associated product bins 406, 408, 410 and 412 in the bulk area 312 and the pick area 314. The visualization 400 also presents item capacities (the bar charts) for each of the associated product bins 406, 408, 410 and 412.

It is to be appreciated that a visualization can be constructed that also includes multiple warehouses such that inter-warehouse drag-and-drop of bins, racks, and product can be achieved. Alternatively, or in combination therewith, the visualization can include an outside area (outside the structure of the warehouse) such that bin and product can be moved outside until such time as picking is to be performed, or picking can be performed from the outside area. Multiple warehouses may be utilized when dealing with perishable products, for example, or high value products that need to be secured until handling.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

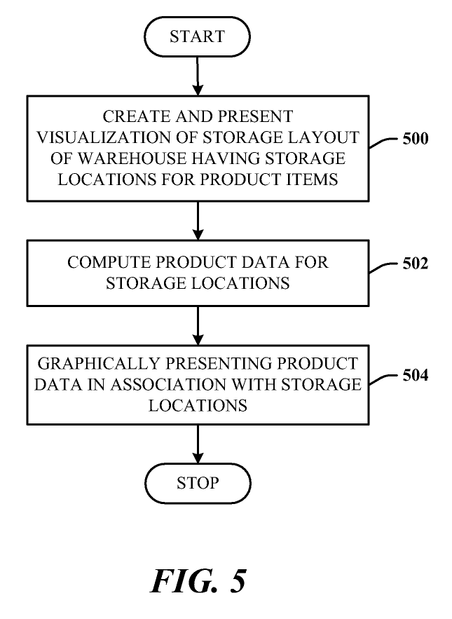

FIG. 5 illustrates a visualization method. At 500, a visualization of a storage layout of a warehouse is created and presented having storage locations for product items. At 502, product data is computed for the storage locations. At 504, the product data is graphically represented in association with the storage locations. The visualization is an interactive rendering for exposing the product data and storage locations relative to top-down views, angular views, and horizontal views of the storage locations.

The method can further comprise applying graphical emphasis to a top of a rack based on changes in the product data, and relocating product items from one storage location to another storage location using an interactive tool.

The method can further comprise applying graphical emphasis to a rack having a storage location associated with a deviating pick rate, applying graphical emphasis to a rack to indicate moving of a storage location to an optimum location in the warehouse, and applying graphical emphasis to other storage locations of product items related to product items of a selected storage location.

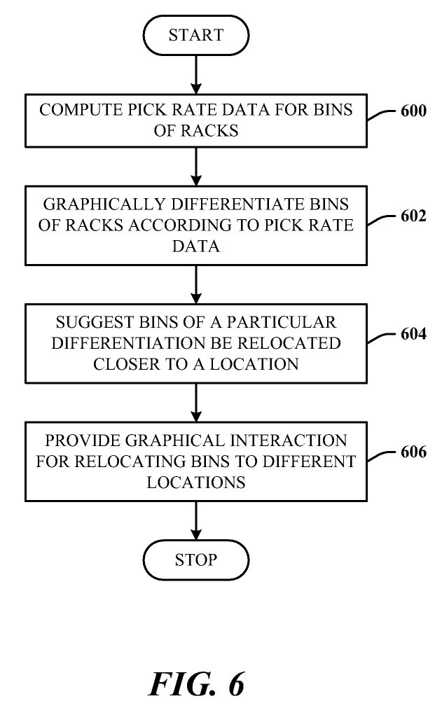

FIG. 6 illustrates a method of providing differentiating graphics for product bins. At 600, the pick rate for bins of racks is computed. At 602, the bins are graphically differentiated according to pick rate data. At 604, bins of a particular differentiation are suggested for relocation closer to a location. At 606, graphical interaction is provided for relocating bins to different locations.

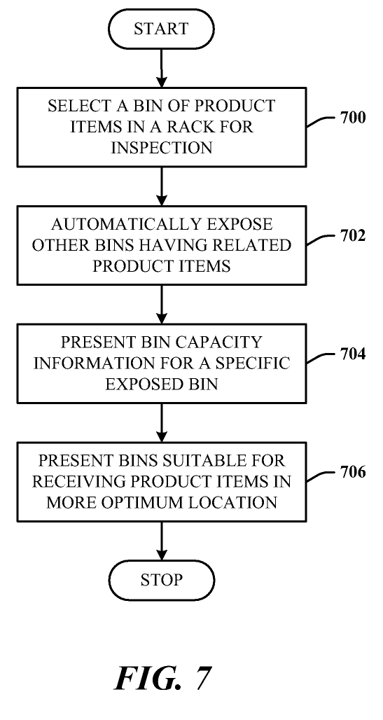

FIG. 7 illustrates a method of product item relocation processing. At 700, a bin of product items in a rack is selected for inspection. At 702, other bins having related product items are automatically exposed. At 704, bin capacity information is presented for a specific exposed bin. At 706, bins suitable for receiving the product items for a more optimum location are presented.

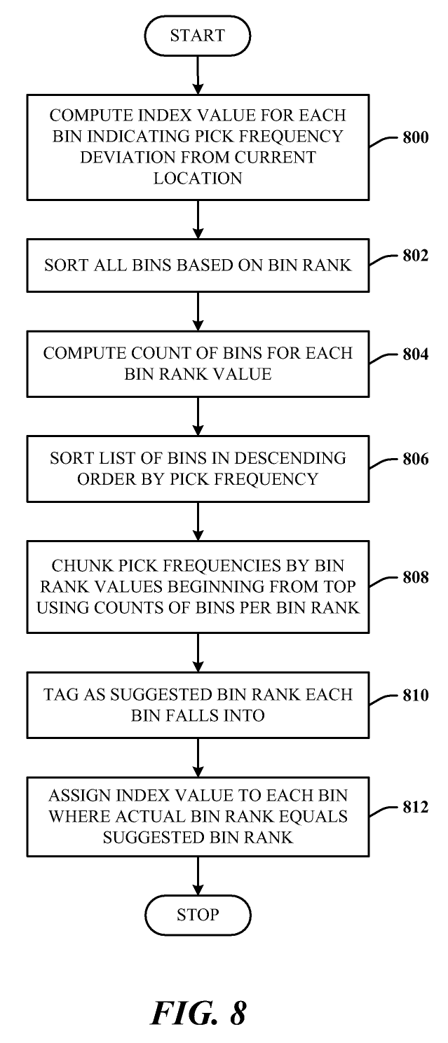

FIG. 8 illustrates a method of suggesting bins for optimized pick location. At 800, an index value is computed for each bin indicating the pick frequency deviation from its current location. At 802, all bins are sorted based on bin rank, the closeness to the packing area. At 804, a count of bins is computed for each bin rank value. At 806, the list of bins is sorted in descending order by pick frequency. At 808, the pick frequencies are chunked by bin rank values beginning from top using count of bins per bin rank. At 810, the bin rank that each bin falls into is tagged as suggested. At 812, each bin is assigned an index value. All bins are assigned an index value that shows how different the pick frequency of the bin is from the expected pick frequency in the bin's bin rank.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

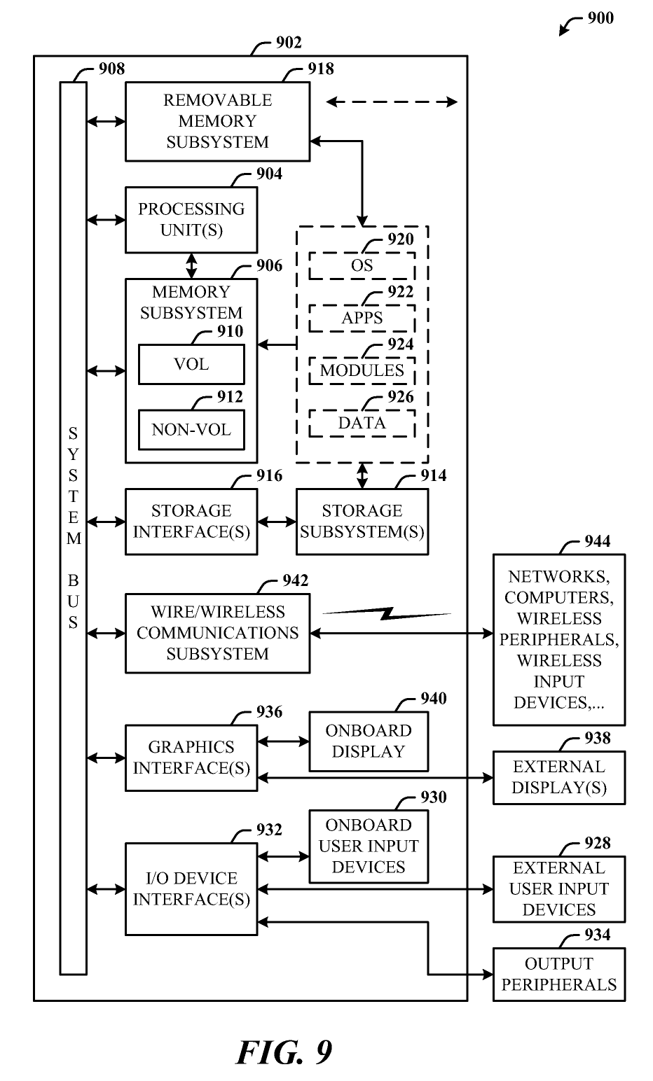

Referring now to FIG. 9, there is illustrated a block diagram of a computing system 900 operable to execute multi-dimensional warehouse layout and interaction visualizations in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914, including an operating system 920, one or more application programs 922, other program modules 924, and program data 926. The one or more application programs 922, other program modules 924, and program data 926 can include the system 100 of FIG. 1, the visualization 200 and associated functionality of FIG. 2, the visualization 300 and associated functionality of FIG. 3, the visualization 400 and associated functionality of FIG. 4, and the methods according to the flow charts of FIGS. 5-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

In a more robust implementation, the disclosed architecture can be run on a touch screen computer where direct user tactile interaction is the interaction mode, and where no mouse, keyboard or microphone, for example, is employed. In a warehouse setting, the touch screen implementation provides advantages where dust and other types of contamination can enter computing hardware and affect operation of the systems.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wired/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented visualization system, comprising:
a structure visualization component for creating and presenting a visualization of a warehouse layout having storage locations for items;
an analysis component for computing activity data of item activity for the storage locations; and
a presentation component for graphically representing the activity data in association with storage locations.

2. The system of claim 1, wherein the visualization of the warehouse is a multi-dimensional view of the layout that includes top-down views and angular views.

3. The system of claim 1, wherein the presentation component graphically represents changes in the activity data using corresponding changes in coloration of the storage locations.

4. The system of claim 1, wherein the visualization includes a mirror metaphor for manipulating views of a storage location.

5. The system of claim 1, wherein the visualization facilitates user interaction for moving items of one storage location to another storage location.

6. The system of claim 1, wherein the presentation component applies visual emphasis to specific storage locations to suggest movement of the specific storage locations to different storage locations.

7. The system of claim 1, wherein the visualization includes a graphical control for selecting a number of suggestions to be presented for item relocation.

8. The system of claim 7, wherein the presentation component maintains presentation of higher priority suggestions in the visualization independent of the number of suggestions selected.

9. The system of claim 1, wherein the presentation component applies emphasis to a specific storage location based on distance of the specific storage location from a work area.

10. A computer-implemented visualization system, comprising:
a structure visualization component for creating and presenting a multi-dimensional visualization of a warehouse layout having storage locations for product items;
an analysis component for computing pick activity data relating to picking items from the storage locations; and
a presentation component for graphically representing the pick activity data in association with storage locations.

11. The system of claim 10, wherein the visualization of the warehouse is a multi-dimensional view of the layout that includes top-down views and side views of the storage locations, the presentation component applies visual emphasis to specific storage locations to suggest movement of the specific storage locations to different storage locations, and the visualization facilitates user interaction for moving items of one storage location to another storage location based on the suggestion.

12. The system of claim 10, wherein the visualization includes a metaphor of mirrors for accessing side views of aisle racks.

13. The system of claim 10, wherein the presentation component graphically represents on top of each rack an indication for a most deviating pick rate of the rack.

14. A computer-implemented visualization method, comprising:
creating and presenting a visualization of a storage layout of a warehouse having storage locations for product items;
computing product data for the storage locations; and
graphically representing the product data in association with the storage locations.

15. The method of claim 14, wherein the visualization is an interactive rendering for exposing the product data and storage locations relative to top-down views, angular views, and horizontal views of the storage locations.

16. The method of claim 14, further comprising applying graphical emphasis to a top of a rack based on changes in the product data.

17. The method of claim 14, further comprising relocating product items from one storage location to another storage location using an interactive tool.

18. The method of claim 14, further comprising applying graphical emphasis to a rack having a storage location associated with a deviating pick rate.

19. The method of claim 14, further comprising applying graphical emphasis to a rack to indicate moving of a storage location to an optimum location in the warehouse.

20. The method of claim 14, further comprising applying graphical emphasis to other storage locations of product items related to product items of a selected storage location.
